(19) United States
(12) Patent Application Publication
(10) Pub. No.: US 2023/0272257 A1
(43) Pub. Date: Aug. 31, 2023

(54) HEAT TRANSFER FLUID

(71) Applicant: BIOBASE SWEDEN AB, BANDHAGEN (SE)

(72) Inventor: Per WIKLUND, Stockholm (SE)

(21) Appl. No.: 17/998,994

(22) PCT Filed: May 14, 2021
(86) PCT No.: PCT/SE2021/050462

§ 371 Date: Nov. 16, 2022

(30) Foreign Application Priority Data
May 17, 2020 (SE) 2050574-9

(51) Int. Cl. C09K 5/20; C09K 3/18; C11D 7/50; C11D 7/26; C11D 11/00

(52) U.S. Cl. CPC C09K 5/20; C09K 3/185; C11D 7/5022; C11D 7/265; C11D 7/261; C11D 11/0035

(57) ABSTRACT

The invention relates to a fluid comprising or consisting of glycerol and potassium acetate in a weight ratio interval of 3:2 to 1:6 with a water content of 55-80 w %, wherein the combined weight of glycerol and potassium acetate constitutes 20-45 w %, up to a maximum or total of 100 w %. The inventive fluid is useful as a heat transfer fluid, a deicing fluid or a windscreen washing fluid. A method for producing the inventive fluid is also provided.

### FIELD OF INVENTION

The present invention relates to heat transfer fluids, and in particular to thermodynamically efficient such fluids based on renewable raw materials

### BACKGROUND

Heat exchange by liquid convection is utilized in many and varied technical applications. It is used in cooling of combustion engines, in air conditioning and heat pumps and temperature control of various industrial processes, as well as in electrotechnical devices such as transformers and certain types of computer processors.

Whereas water has lower viscosity, higher heat capacity and heat conductivity than just about any generally available liquid, it offers only a small window of operating temperatures between its freezing and boiling points (0 to 100° C.). Water is also not a good solvent for organic compounds that may serve as corrosion inhibitors. For these reasons water is commonly mixed with polar organic compounds with high solubility in water, such as alcohols and polyols in order to furnish technically superior heat transfer fluids. This gives fluids of significantly lower freezing points and slightly higher boiling points. A limitation with alcohols, such as methanol and ethanol, is the flammability even of dilute solutions which puts restrictions on their use. These limitations do not apply to polyols, such as ethylene glycol, propylene glycol and glycerol.

Aqueous mixtures of ethylene glycol (ethane-1,2-diol), also known as monoethylene glycol (MEG), is despite its toxicity the most commonly used heat transfer fluid in the operating temperature window −40 to +100° C. The reason is the general availability, low cost and high technical performance. For automotive use, a mixture of 50 vol % water with MEG, with added corrosion inhibitors, is a common standard. A MEG concentrate (often called Antifreeze or Coolant concentrate) with added corrosion inhibitors is sold over the counter for dilution with water by the final user. When mixed with 50 vol % water these concentrates give a heat transfer fluid with a freezing point of around −36° C. depending on the amount and type of corrosion inhibitors and other additives present. Because of the norm to use such a product, cooling/heating systems are commonly designed for a liquid of similar thermodynamic properties. MEG is produced industrially in very large scale from ethylene of fossil origin by cracking of hydrocarbons to furnish ethylene, followed by oxidation and reaction with water. The sweet taste of MEG in combination with its acute toxicity poses a health and safety problem, and bitter tasting additives are often added to prevent accidental intake by humans or animals.

A relatively common replacement for MEG, in cases where the toxicity is an issue, is propylene glycol (propane-1,2-diol, herein called PPG) [1]. Notably aqueous PPG solutions are used in machinery for forestry and in marine applications. PPG is not toxic and is also used in food and beverages, pharmaceuticals, and cosmetics. Like MEG it has antibacterial and fungicidal properties. As replacement for MEG in low temperature heat transfer fluids it suffers from high viscosity (FIG. 1) and higher freezing point at the same concentration. Commercial PPG usually has a fossil origin, although it can be produced from biogenic glycerol.

There are standards for the use of aqueous glycerol solutions in automotive cooling (ASTM D7714 and D7715), but such solutions give even higher viscosities than PPG and it is not a good engineering solution when better alternatives are available. Biogenic glycerol is commercially available in large scale as a byproduct of production of FAME-type biodiesel. Like MEG and PPG it has a sweet taste, but it is non-toxic.

Patent application US20070012896A1 [7] discloses deicing compositions constituting e.g., glycerol and potassium acetate in a weight ratio interval of 1:1, a water content of 50 w %, and a combined weight of glycerol and potassium acetate of 50 w %. However, said document does not provide any thermodynamic data, except kinematic viscosity at −7 and +22° C. and freezing point (−41° C.).

Polyols can be oxidized to the corresponding carboxylic acids by the action of microbes, and therefore MEG- and PPG-based heat transfer fluids (despite their antimicrobial properties) can over time become corrosive to metals. This effect can be prevented and mitigated by control of the pH of the solutions ensuring a moderately alkaline environment in which most metals are not rapidly corroded.

For low temperature heat transfer fluids for use other than in automotive applications, it is common to dissolve inorganic or organic salts in water to lower the freezing point. Some inorganic salts give extremely low freezing points, but at the price of very high corrosivity towards most engineering metals. Alternatively, formates and acetates, usually with potassium as counterion, can be used, which give much less pronounced corrosivity. Such solutions are naturally alkaline which contributes to the lower corrosivity.

For the most common aqueous heat transfer fluids there is detailed collected tabulated physical properties published [2] and [3]. There is also an instructive methodological monograph by the same author [4].

As can be seen from the above, there is a need for an improved heat transfer fluid, exhibiting state of the art heat transfer and low freezing point while at the same time being environmentally friendly and based on renewable materials.

### SHORT DESCRIPTION OF THE INVENTION

The invention relates to a heat transfer fluid comprising or consisting of glycerol and potassium acetate in a weight ratio interval of 2:3 to 1:5 with a water content of 55-80 w %, wherein the combined weight of glycerol and potassium acetate constitutes 20-45 w %, e.g. 20-40 w %, up to a total of 100 w %. The weight ratio interval of glycerol and potassium acetate may be any of 2:3, 1:2, 1:3, 1:4, or 1:5. The water content may be 55, 56, 57, 58, 59, 60, 65, 70, 75, or 80 w %, and the combined weight of glycerol and potassium acetate may be 20, 25, 30, 35, 40, or 45 w %, up to a maximum or total of 100 w %. Intervals may be composed using any of the above endpoints, in any combination of components contained or comprised in the fluid. The fluid can be manufactured through neutralization of aqueous acetic acid, e.g. aqueous biogenic acetic acid, with potassium hydroxide or potassium carbonate, followed by addition of glycerol to the neutralized solution.

### SHORT DESCRIPTION OF THE FIGURES

FIG. 1 shows the viscosity as function of temperature for 50 w % MEG [2] and 50 w % PPG [2] glycol compared to innovative fluid (Entry 4, Table 2). The dynamic viscosity of the latter was measured by cooling/heating of the liquid and the probe of a Viscolite 700 portable viscometer to the measurement temperature, using the probe to gently mix/homogenize the sample prior to taking the measurement. The procedure was also applied to 50 w % MEG almost exactly reproducing the literature data [2].

FIG. 2 shows the freezing point as function of content of Potassium Acetate [2], Ethylene glycol [2] and Glycerol [5] in water respectively.

FIG. 3 shows the mass heat capacity of two different concentrations of Potassium Acetate in water [2] and the innovative fluid (Entry 4, Table 2). The latter curve was recorded using a published procedure based on microDSC [6].

FIG. 4 shows the volume heat capacity of the innovative fluid (Entry 4, Table 2) compared to literature data [2] for the indicated fluids. The data for the innovative fluid is based on the same data underlying the graph in FIG. 3 combined with density over temperature data obtained in the same manner as the density data in Table 1.

FIG. 5 shows the thermal conductivity of the innovative fluid (Entry 4, Table 2) compared to literature data [2] for the indicated fluids. Data for the innovative fluid was obtained through application of the transient hot wire method [8].

### DETAILED DESCRIPTION OF THE INVENTION

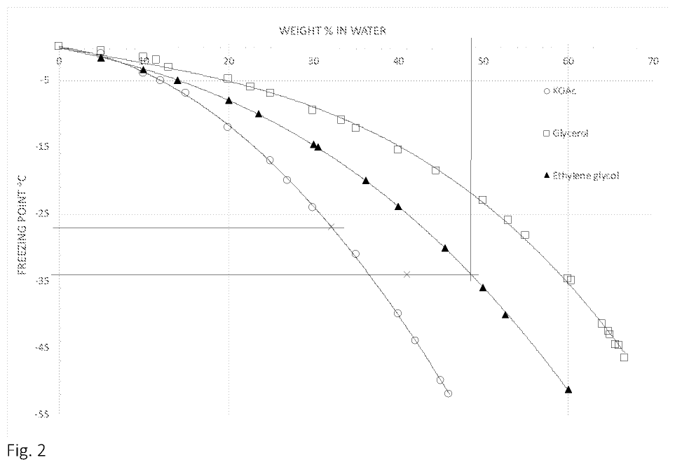

It has unexpectedly been found that an aqueous heat transfer fluid closely matching the viscosity over temperature behavior of MEG in water can be prepared from household aqueous acetic acid (24 w %) by neutralization with potassium hydroxide or potassium carbonate, followed by addition of a portion of glycerol. Both glycerol and acetic acid can be of biological origin and hence a product based on renewable raw materials can be produced. Considering the weak freezing point depression effect of glycerol as compared to that of potassium acetate (FIG. 2), this result is surprising.

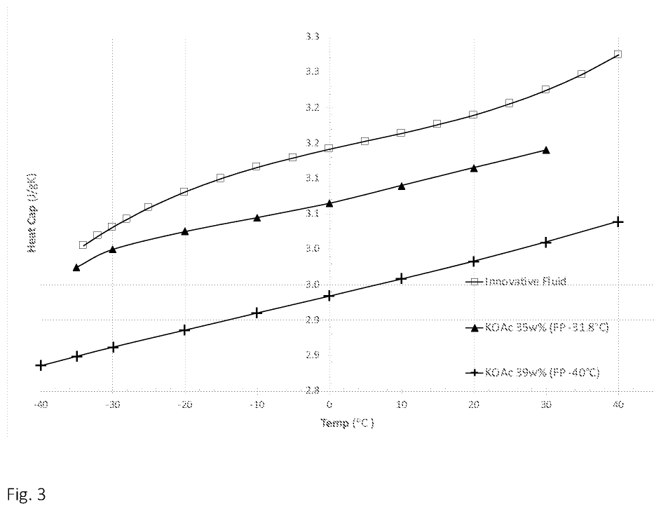

The rationale for the observed effect is that glycerol addition lowers the water content of the mixture, thereby lowering the freezing point, but it is not obvious from literature that the two compounds combined give this effect. Compared to evaporation of water from a solution of potassium acetate in order to lower the freezing point, glycerol addition is energetically favorable as the heat of evaporation of water is very high. Furthermore, the thermodynamic properties of a system consisting of potassium acetate, glycerol and water were found to have higher heat capacity than solutions of potassium acetate of similar freezing points (FIG. 3).

Biogenic acetic acid can be produced in several different ways and from different ultimate raw materials. These production methods usually involve the action of microbes (yeast or bacteria) on ethanol in aqueous solution. This means that to produce pure acetic acid invariably requires evaporation of water, requiring high energy input. Direct industrial utilization of acetic acid in dilute aqueous solution is therefore highly beneficial.

The fluid as claimed can be used as heat transfer fluid, deicing fluid, and vehicle windscreen washer fluid. As used herein, the term heat transfer fluid may comprise deicing fluid and windscreen washer fluid, respectively.

The invention shall now be described with reference to the following Examples, which shall merely be seen as exemplifying embodiments of the invention. The skilled person realizes that adjustments may be made, without departing from the inventive concept.

Prior art discloses a 1:1:2 mixture of glycerol, potassium acetate and water, and a suggested use thereof as a heat transfer fluid [7]. However, no thermodynamic data except kinematic viscosity at −7 and +22° C. and freezing point (−41° C.) is disclosed therein.

As a comparison with prior art, three solutions were prepared as shown in Table 1. The dynamic viscosities were measured using a Viscolite 700 portable viscometer. Densities were measured by retrieval of the fluid at the specified temperature with a calibrated automatic pipette followed by weighing of the sample retrieved.

TABLE 1

| Case | 1 | 2 | 3 |
|---|---|---|---|
| Glycerol (g) | 50 | 25 | 75 |
| KOAc (g) | 50 | 75 | 25 |
| Water (g) | 100 | 100 | 100 |
| Density @ 25° C. (kg/liter) | 1.171 | 1.222 | 1.155 |
| Viscosity @ 25° C. (mPa s) | 6 | 6 | 6 |
| Viscosity @ 0° C. (mPa s) | 20 | 17 | 17 |
| Physical state @ −41° C. | Floating | Liquid | Solid |
| | needles | | |
| Viscosity @ −40° C. (mPa s) | 225 | 213 | NA |

Because of the outstanding heat transfer properties of water, a limiting minimum water content to achieve good thermodynamic properties was taken to be 50 w %, which is also reasonable from the perspective of producing a heat transfer fluid comparable to 50 vol % MEG in water (52.6 w %). Case 1 replicates the example from [7], and the freezing point was confirmed.

In accordance with the invention, a lower freezing point can be achieved by a smaller ratio of glycerol to potassium acetate, at the same water content. This is confirmed through Case 2, showing a lower viscosity than for Case 1 at the lower temperatures.

For reason of comparison, the ratio of glycerol to potassium acetate was inverted, as compared with Case 2 (see Case 3). As can be seen, the freezing point was clearly higher in Case 3, albeit with a lower viscosity at 0° C. Furthermore, the fluid of Case 2 showed the highest density, which is a clear advantage for a heat transfer fluid in most applications. All else equal, a higher density gives a higher volumetric heat capacity, i.e. more thermal mass for a given volume. High density also contributes to high thermal conductivity. Put in another way, more heat can be absorbed and dissipated through a certain volume of a fluid of higher density compared to one of lower density.

### Examples

Precise measurement of freezing points, at mixing ratios other than those forming eutectic mixtures, is not possible as the mixed material does not display a single temperature of freezing. In other words, what is observed is often a slush state in which the frozen material does not have the same molecular composition as the liquid state.

### Fluid

To a solution of potassium acetate (39.2 g) in deionized water (83.2 g), portions of water free glycerol were added. Guided by the results shown in Table 1, the maximum amount of glycerol added was equal to the molar amount of potassium acetate. The resulting solutions were placed in a freezer set to a specific temperature (+/−0.5° C.) for 24 hours. The physical states of the solutions were then observed. None of the samples at any of the temperatures were homogenously frozen solid (cmp. Case 3, Table 1 where glycerol was present in higher molar amount than potassium acetate), rather three different states could be distinguished. At the lowest temperatures and lowest amount of glycerol added, samples were in a slush state. At the boundary between slush and liquid, a state in which only a few isolated needle shaped crystals were floating on top of a homogenous liquid could be identified. The lowest temperature of this state was taken as the freezing point of that particular mixture.

TABLE 2

| Glycerol | Molar ratio | Weight ratio | Water | | | | | |
|---|---|---|---|---|---|---|---|---|
| addition | Glycerol to | Glycerol to | Content | Freezer temperature (° C.) | | | | |
| (g) | KOAc | KOAc | (w %) | −39 | −37 | −34 | −31 | −27 |
| 0 | 0 | 0 | 68.0 | Slush | Slush | Slush | Slush | Needles |
| 9.20 | 0.25 | 0.23 | 63.2 | Slush | Slush | Slush | Needles | Liquid |
| 12.3 | 0.33 | 0.31 | 61.8 | Slush | Slush | Slush | Needles | Liquid |
| 18.4 | 0.50 | 0.47 | 59.1 | Slush | Slush | Needles | Needles | Liquid |
| 24.5 | 0.67 | 0.63 | 56.6 | Slush | Slush | Needles | Liquid | Liquid |
| 27.6 | 0.75 | 0.70 | 55.5 | Slush | Needles | Liquid | Liquid | Liquid |
| 36.8 | 1.00 | 0.94 | 52.3 | Slush | Liquid | Liquid | Liquid | Liquid |

Potassium acetate is preferred over sodium acetate for reasons of solubility. It was found that although combinations of sodium acetate, water and glycerol can stay liquid at a range of temperatures down to below −30° C., these mixtures suffer from precipitation of sodium acetate out of solution at temperatures near the respective freeing points. In these cases, substantial amounts of sodium acetate stay undissolved even when the temperature of the sample is again raised to room temperature. In contrast the formulations in Table 2 with potassium acetate show no such behavior even after prolonged storage at a temperature of −45° C.

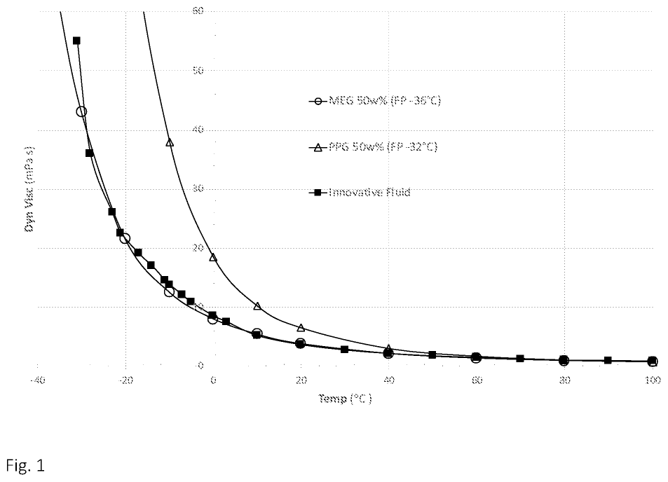

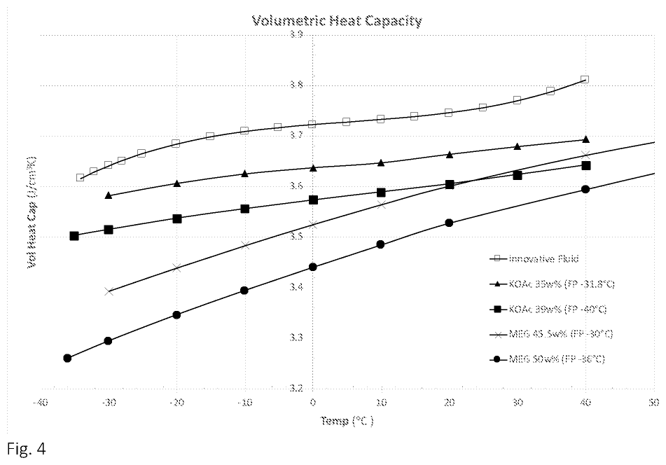

In-depth thermodynamic studies were performed on the heat transfer fluid as claimed, with a molar ratio of potassium acetate to glycerol of 2:1 (Entry 4, Table 2). At that ratio the addition of glycerol provides the synergistic effect on freezing point and maintains a viscosity at low temperatures closely matching that of MEG/water-mixtures of similar freezing points (FIG. 1). Furthermore, the innovative heat transfer fluid was found to have higher mass heat capacity than fluids based only on potassium acetate at similar freezing points (FIG. 3), and higher volumetric heat capacity than MEG/water-mixtures of similar freezing points (FIG. 4). Minor deviations from the 2:1 ratio of potassium acetate to glycerol have minimal effect on these properties, since in the claimed ranges it is the water content that has the highest effect.

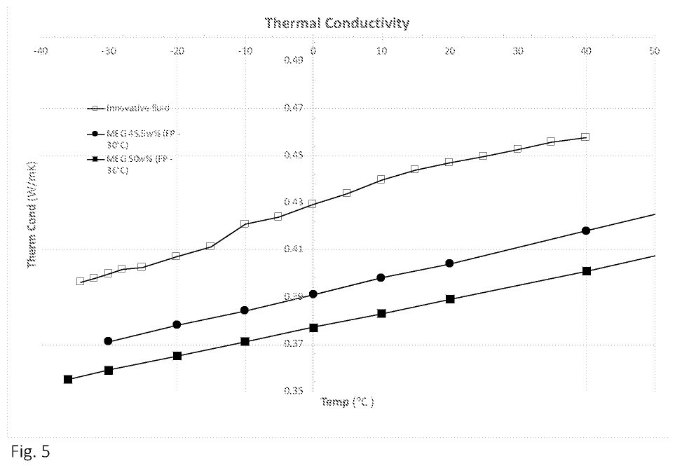

Additionally, the fact that a higher density contributes also to a higher heat conductivity is clearly supported for the innovative fluid (FIG. 5).

An important observation is that when the innovative fluid was left in an open container at 25° C., the freezing point gradually decreased as water evaporated. Considering that both potassium acetate and glycerol are hygroscopic, this observation is very noteworthy. From a practical application point of view this decrease of freezing point is beneficial as the user of the fluid never has to doubt the low freezing point even after extended periods of time. The observation also has implications for production of the heat transfer fluid as it is possible to start from more diluted mixture and by evaporation (natural or forced by lowering of pressure) arrive at the intended freezing point.

### Method of Producing a Renewable Fluid According to the Invention

Neutralization of aqueous (biogenic) acetic acid (24 w %) with anhydrous potassium hydroxide gives a solution with freezing point −27° C. Addition of a portion of glycerol corresponding to a molar amount of half of the formed potassium acetate gives a mixture with a freezing point of −34° C. at a water content of 59 w %. If MEG is mixed with 59 w % water a freezing point of only −25° C. is achieved. To reach −34° C. MEG must be mixed with 52 w % water (FIG. 1).

Alternatively, for production of a heat transfer fluid based only on acetate from biogenic acetic acid, the neutralization of acetic acid can be followed by partial evaporation of the water contained in the mixture. Although this gives a fluid of the same freezing point at a moderate energy consumption, the electrical conductivity for such a fluid would be higher, which potentially has an adverse effect on corrosion rates. As shown above (FIG. 3), such a fluid also has lower heat capacity compared to the innovative fluid.

It should also be noted that although neutralization of acetic acid by potassium hydroxide is a strongly exothermic reaction, the heat released when acetic acid (24 w %) in water is thus treated is not enough to evaporate enough water to create a fluid of the same low freezing point as is achieved by addition of the portion of glycerol.

Neutralization of biogenic acetic acid (12 w %) with potassium hydroxide yielded a fluid of freezing point −9° C. After addition of a portion of glycerol corresponding to half the molar amount of potassium acetate in solution, the freezing point was found to be −15° C. for the mixture containing 76 w % water.

As compared to heat transfer fluids based on 50 vol % MEG in water, it is thus possible to produce a heat transfer fluid with a similar freezing point, higher water content, higher heat capacity, and the same viscosity over temperature profile from renewable materials using a low amount of energy.

Corrosivity of the inventive heat transfer fluid can be controlled by addition of corrosion inhibitors and/or control of the pH of the fluid. The main corrosion issue when MEG or PPG is used as heat transfer fluid components is that (bio) oxidation of the polyols lead to formation of carboxylic acids which in turn can corrode metals. As the rate of corrosion for most metals is reasonably low a mildly alkaline conditions, MEG/PPG-based fluids are often buffered to such conditions. Solutions containing Potassium acetate naturally give a pH in the very useful region 7-8.5 [4] depending on concentration. In accordance with the invention, buffers cannot generally be based on acid-base equilibria, where presence of the acid would give formation of acetic acid. However, equilibria of species always yielding alkaline solutions work well. Potassium bicarbonate combined with Potassium carbonate can be used to buffer the fluid to a pH in the range 9-11 making it possible to change the pH to what is appropriate for the metals used in a particular system. Nitrites, phosphates, silicates and benzotriazole [4] as well as anions of carboxylic acids with reasonably high solubility such as 2-ethylhexanoic acid and benzoic acid can further be used as corrosion inhibitors.

MEG/PPG-based fluids are often colored with dyes for easy recognition. For the inventive fluid the same (often food grade colorants) can be used, but also pH-indicators such as e.g. thymol blue, cresol red, cresolphthalein, phenolphthalein, thymolphthalein which may assist in the production by showing a color change when the predetermined alkaline pH has been achieved (titration).

### The Invention in Bullet Points:

Fluid comprising glycerol and potassium acetate in a weight ratio interval of 2:3 to 1:5 with a water content of 55-80 w %, wherein the combined weight of glycerol and potassium acetate constitutes 20-45 w %, up to a maximum of 100 w %.

2. Fluid consisting of glycerol and potassium acetate in a weight ratio interval of 2:3 to 1:5 with a water content of 55-80 w %, wherein the combined weight of glycerol and potassium acetate constitutes 20-45 w %, up to a total of 100 w %.

3. Fluid according to item 1 or 2, wherein the potassium acetate and/or glycerol are biogenic.

4. Fluid according to any of items 1 or 3, further comprising anti-corrosive additive(s).

5. Fluid according to item 4, wherein the anti-corrosive additive(s) are chosen from the group consisting of nitrates, phosphates, silicates, organic acids and benzotriazole.

6. Fluid according to any of items 1, 3-5, further comprising coloring agent(s).

7. Fluid according to any of items 1-6, having a pH in the range of 7 to 9.

8. Fluid according to any of items 1, 3-7, further comprising a buffer system bringing the pH into the range of 9 to 11.

9. Fluid according to any of items 1-8, having a viscosity lower than 18 mPa s at 0° C. and lower than 8 mPa s at 40° C.

10. Fluid according to any of items 1-9, having a freezing point in the interval from −45 to −10° C.

11. Method of producing a heat transfer fluid, a deicing fluid or a windscreen washer fluid according to any of the preceding items, comprising
neutralization of aqueous acetic acid with potassium hydroxide or potassium carbonate;
b1) addition of glycerol to the neutralized solution;
c) packaging of the solution obtained in containers of volume 1 to 1000 liters.

12. Method according to item 11, wherein in a step b2) water is fully or partially evaporated.

13. Method according to item 11 or 12, wherein a buffer system and/or additive is added in step b1).

14. Method according to any of items 11-13, wherein an anti-corrosive additive is added in step b1).

15. Method according to any of items 11-14, wherein the aqueous acetic acid has a concentration of 10-50 w %, the amount of potassium hydroxide or potassium carbonate is equimolar to the acetic acid amount, and the glycerol amount is 20-100% of the weight of the potassium acetate formed.

16. Use of a fluid according to any of items 1-10 as a heat transfer fluid.

17. Use of a fluid according to any of items 1-10 as a deicing fluid.

18. Use of a fluid according to any of items 1-10 as a windscreen washing fluid.

### LITERATURE REFERENCES

[1] “Iso-paraffins as low temperature secondary fluids”; Ignatowicz et al.; 5^{th} IIR Conference on Thermophysical Properties and Transfer Processes of Refrigerants, 2017
[2] “Properties of Secondary Working Fluids (Secondary Refrigerants or Coolants, Heat Transfer Fluids) for Indirect Systems” Åke Melinder, 2010, 2^{nd} ed., Iif-iir—France, ISBN 9782913149830
[3] “Thermophysical Properties of Aqueous Solutions Used as Secondary Working Fluids”; Åke Melider, 2007; Doctoral Thesis Royal Institute of Technology, Stockholm, Sweden
[4] “Handbook on indirect refrigeration and heat pump systems”; Ed. Åke Melinder, Svenska Kyltekniska Föreningen, 2015
[5] “Freezing Points of Glycerol and Its Aqueous Solutions”; Leonard B Lane, Ind. Eng. Chem. 1925, 17, 9, 924-924
[6] “Cesium and ammonium salts as low temperature secondary fluids”; Ignatowicz et al.; Proceedings of the 25^{th} IIR International Congress of Refrigeration: Montréal, Canada, Aug. 24-30, 2019
[7] US20070012896A1
[8] “The theory of the transient hot-wire method for measuring thermal conductivity” J J Healy et al., Physica B+C, Volume 82, issue 2, April 1976, pages 392-408

1. A fluid comprising glycerol and potassium acetate in a weight ratio interval of 2:3 to 1:5 with a water content of 55-80 w %, wherein the combined weight of glycerol and potassium acetate constitutes 20-45 w %, up to a maximum of 100 w %.

2. A fluid consisting of glycerol and potassium acetate in a weight ratio interval of 2:3 to 1:5 with a water content of 55-80 w %, wherein the combined weight of glycerol and potassium acetate constitutes 20-45 w %, up to a total of 100 w %.

3. The fluid according to claim 1, wherein the potassium acetate and/or glycerol are biogenic.

4. The fluid according to claim 1, further comprising anti-corrosive additive(s).

5. The fluid according to claim 4, wherein the anti-corrosive additive(s) are chosen from the group consisting of nitrates, phosphates, silicates, organic acids and benzotriazole.

6. The fluid according to claim 1, further comprising coloring agent(s).

7. The fluid according to claim 1, having a pH in the range of 7 to 9.

8. The fluid according to claim 1, further comprising a buffer system bringing the pH into the range of 9 to 11.

9. The fluid according to claim 1, having a viscosity lower than 18 mPa s at 0° C. and lower than 8 mPa s at 40° C.

10. The fluid according to claim 1, having a freezing point in the interval from −45 to −10° C.

11. A method of producing the fluid according to claim 1, wherein the fluid is a heat transfer fluid, a deicing fluid or a windscreen washer fluid, comprising steps of:
a) neutralization of an aqueous acetic acid solution with potassium hydroxide or potassium carbonate;
b1) addition of glycerol to the neutralized solution;
c) packaging of the solution obtained in containers of volume 1 to 1000 liters.

12. The method according to claim 11, further comprising a step of b2) evaporating water, fully or partially, from the neutralized solution to which glycerol has been added.

13. The method according to claim 11, wherein a buffer system and/or additive is added to the neutralized solution in step b1).

14. The method according to claim 11, wherein an anti-corrosive additive is added to the neutralized solution in step b1).

15. The method according to claim 11, wherein the aqueous acetic acid has a concentration of 10-50 w %, the amount of potassium hydroxide or potassium carbonate is equimolar to the acetic acid amount, and the glycerol amount is 20-100% of the weight of the potassium acetate formed.

16. A method of use of the fluid according to claim 1, comprising using the fluid as a heat transfer fluid.

17. A method of use of the fluid according to claim 1, comprising using the fluid as a deicing fluid.

18. A method of use of the fluid according to claim 1, comprising using the fluid as a windscreen washing fluid.

19. The fluid according to claim 2, wherein the potassium acetate and/or glycerol are biogenic.

20. The fluid according to claim 2, having a pH in the range of 7 to 9, having a viscosity lower than 18 mPa s at 0° C. and lower than 8 mPa s at 40° C., and/or having a freezing point in the interval from −45 to −10° C.
